(19) United States
(12) Patent Application Publication
(10) Pub. No.: US 2009/0155660 A1
(43) Pub. Date: Jun. 18, 2009

(54) TUBULAR SOLID OXIDE FUEL CELLS

(75) Inventors: Ji Hang YU, Yuseong-gu (KR); Sang Kuk Woo, Yuseong-gu (KR); In Sub Han, Yuseong-gu (KR); Kee Seog Hong, Seo-gu (KR); Doo Won Seo, Gongju-si (KR); Se Young Kim, Seongnam-si (KR)

Correspondence Address: MCDERMOTT WILL & EMERY LLP, 600 13TH STREET, N.W., WASHINGTON, DC, 20005-3096, US

(73) Assignee: KOREA INSTITUTE OF ENERGY RESEARCH

(21) Appl. No.: 12/368,422

(22) Filed: Feb. 10, 2009

(30) Foreign Application Priority Data
Dec. 14, 2007 (KR) 10-2007-0131304

(51) Int. Cl. H01M 8/10

(52) U.S. Cl. 429/31

(57) ABSTRACT

Tubular solid oxide fuel cells are provided. In one embodiment, fluid flow channels are defined by a plurality of bridges between a core and an outer wall of an electrode support. In another embodiment, a fluid supply channel and fluid discharge channels of an electrode support are formed in a double-wall structure. Electric current distribution and gas distribution are facilitated in the solid oxide fuel cells.

### BACKGROUND OF THE INVENTION

1. Field of the Invention

The present invention relates to tubular solid oxide fuel cells. More specifically, the present invention relates to tubular solid oxide fuel cells in which fluid flow channels are defined by a plurality of bridges between a core and an outer wall of an electrode support, or a fluid supply channel and fluid discharge channels of an electrode support are formed in a double-wall structure, thus enabling distribution of electric current and gas in an easier manner.

2. Description of the Related Art

A typical solid oxide fuel cell (SOFC) consists essentially of an anode (or a fuel electrode), a cathode (or an air electrode) and an ionically conductive electrolyte (e.g., yttria-stabilized zirconia (YSZ)) attached between the two electrodes. Generally, the solid electrolyte such as YSZ has a dense structure to prevent fuel from being mixed with air, whereas the anode and the cathode have porous structures to ensure smooth diffusion of fuel and air, respectively.

SOFCs are broadly divided into planar and tubular types in structure. Tubular SOFCs are subdivided into cylindrical and flat tubular types. A flat tubular SOFC is made flat such that it is easily connected to adjacent cells. Generally, high power density and low resistance of a planar or tubular SOFC are achieved by coating an electrolyte on an electrode support to form a thin film.

The use of a metal or ceramic connecting plate in a planar SOFC is advantageous in cell stacking and current collection, but makes it difficult to fabricate the cell in a large area and necessitates the use of a sealing material to separate flows of fuel and air on and under the cell.

A tubular SOFC has high mechanical strength and is easy to control inward and outward flows of gases. However, the tubular SOFC has difficulty in collecting or distributing an electric current from an inner electrode and suffers from the disadvantage of high resistance. To solve these problems, U.S. Pat. No. 5,229,224 suggests the insertion of an additional metal or metal-ceramic composite (cermet) tube to collect an electric current. However, the inserted tube may be in loose contact with an electrode tube at high temperature due to the difference in coefficient of thermal expansion between the tubes. In this case, the contact resistance between the tubes increases, resulting in a deterioration in the performance of the cell. In addition, the fabrication process of the unit cell is complex and the fabrication cost of the cell increases.

A support of the tubular SOFC is usually made by an extrusion process. In view of ease of molding and transport, the tube must have a sufficiently thick wall. However, an increased thickness of the support decreases the diffusion rate of gas, resulting in an increase in the resistance of the cell. In comparison with the tubular cell, the planar cell can use a thin support to achieve high power performance.

Methods for simplifying the structures of a stack of tubular SOFCs have been developed (U.S. Pat. Nos. 6,444,342, 6,936,367 and 6,656,623). According to these methods, a first tube whose one end is closed and the other end is open is prepared, a second tube is inserted through the open end of the first tube, and gas is introduced into the first tube through the second tube and is preheated within the cell. However, troublesome problems of the methods are that the additional gas introduction tube must be inserted and that a manifold must be specially designed to independently fix the cell and the introduction tube, rendering the fabrication process complicated.

Hydrocarbon fuel, such as methane, propane or diesel oil, can be used without any additional fuel processor in a fuel electrode-supported SOFC because the fuel is processed by an anode material at high temperature. However, when the fuel electrode-supported SOFC is operated at a relatively low temperature of 500-800° C., carbon is deposited on the fuel electrode to degrade the performance of the fuel electrode. An additional fuel processor is needed to prevent carbon deposition, incurring an increase in the fabrication costs of the system. Further, the bulky fuel processor increases the fabrication costs and volume of a portable SOFC that is operated at low temperature, is easy to carry and uses hydrocarbon fuel.

### SUMMARY OF THE INVENTION

It is an object of the present invention to solve the problems of the prior art and to provide a tubular solid oxide fuel cell that uses a tubular electrode support with reduced wall thickness and high mechanical strength while maintaining a good flow of electric current Another object of the present invention is to provide a tubular solid oxide fuel cell in which a smooth flow of gas within a tube is maintained without the need to insert an additional tube.

Yet another object of the present invention is to provide a one-piece tubular solid oxide fuel cell that uses a double-walled tubular fuel electrode support to induce fuel processing reactions.

According to one embodiment of the present invention, there is provided a tubular solid oxide fuel cell which comprises: a tubular electrode support including a core, an outer wall and a plurality of bridges connecting the core to the outer wall; fluid flow channels defined by the bridges between the core and the outer wall of the electrode support; an electrolyte layer coated on the outer surface of the electrode support; and an electrode formed on the outer surface of the electrolyte layer.

Preferably, the core, the bridges and the outer wall are integrated with each other.

Preferably, the number of the bridges of the electrode support is at least three.

The electrode support may have a circular or polygonal shape in cross section.

The electrolyte layer may be formed by dip coating or painting a powder of a ceramic material selected from yttria-stabilized zirconia, (La,Sr)(Ga, Mg)O₃, Gd-doped CeO₂ and Ba(Zr,Y)O₃ on the electrode support.

According to another embodiment of the present invention, there is provided a tubular solid oxide fuel cell which comprises: a tubular electrode support including a core, an outer wall and a plurality of bridges connecting the core to the outer wall; a fluid supply channel penetrating the central portion of the core of the electrode support; fluid discharge channels defined by the bridges between the core and the outer wall of the electrode support to allow a fluid supplied from the fluid supply channel to be discharged therethrough; an electrolyte layer coated on the outer surface of the electrode support; and an electrode formed on the outer surface of the electrolyte layer.

Preferably, the tubular solid oxide fuel cell further comprises a stopper formed at one end of the electrode support opposite to an inlet of the fluid supply channel to close the end of the electrode support and to allow a fluid supplied through the inlet of the fluid supply channel, which is in flow communication with the fluid discharge channels at the end of the electrode support, to be discharged through the fluid discharge channels.

Preferably, the fluid supplied from the fluid supply channel is discharged through the fluid discharge channels while undergoing electrochemical reactions through the outer wall.

Preferably, the fluid supply channel formed within the electrode support is supported to the outer wall through the bridges to increase an electric current while preheating the fluid introduced thereinto.

Preferably, the fluid supply channel formed within the electrode support contains or is coated with a catalytic material for inducing processing reactions of the fluid and successive electrochemical reactions to generate an electric current.

Preferably, the catalytic material contained in or coated on the fluid supply channel induces catalytic combustion of the fuel to increase the overall temperature of the cell.

Preferably, the stopper is formed with a cover layer on the outer wall thereof to prevent the fluid from leaking out of the electrode support.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1a is a cross-sectional view of an electrode support of a tubular solid oxide fuel cell according to one embodiment of the present invention, FIG. 1b is a cross-sectional view of a solid oxide fuel cell in which an electrolyte layer and an electrode are sequentially coated on the surface of the electrode support illustrated in FIG. 1a, and FIG. 1c is a front view of a cylindrical solid oxide fuel cell constructed such that the core illustrated in FIG. 1b protrudes to facilitate current collection;

FIGS. 2a through 2c are cross-sectional views of tubular solid oxide fuel cells according to other embodiments of the present invention;

FIG. 3a is a cross-sectional view of an electrode support of a tubular solid oxide fuel cell according to another embodiment of the present invention, FIG. 3b is a cross-sectional view of a solid oxide fuel cell in which an electrolyte and an electrode are sequentially coated on the surface of the electrode support illustrated in FIG. 3a, and FIGS. 3c and 3d are a front view and a cross-sectional view of a cylindrical solid oxide fuel cell constructed such that the core illustrated in FIG. 3b protrudes to facilitate current collection, respectively; and

FIG. 4 is a cross-sectional view of a tubular solid oxide fuel cell according to another embodiment of the present invention.

### DETAILED DESCRIPTION OF THE INVENTION

Preferred embodiments of the present invention will now be described in detail with reference to the accompanying drawings in such a manner that they can easily be carried out by a person having ordinary skill in the art to which the invention pertains.

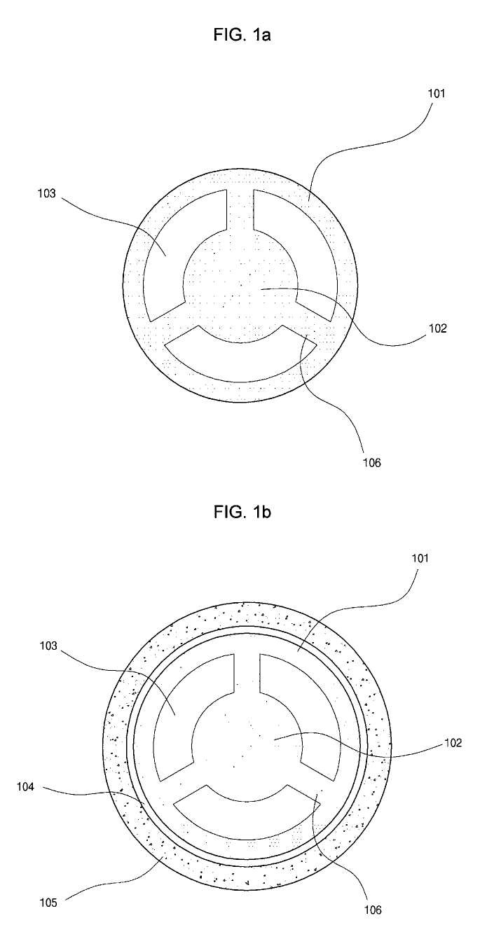

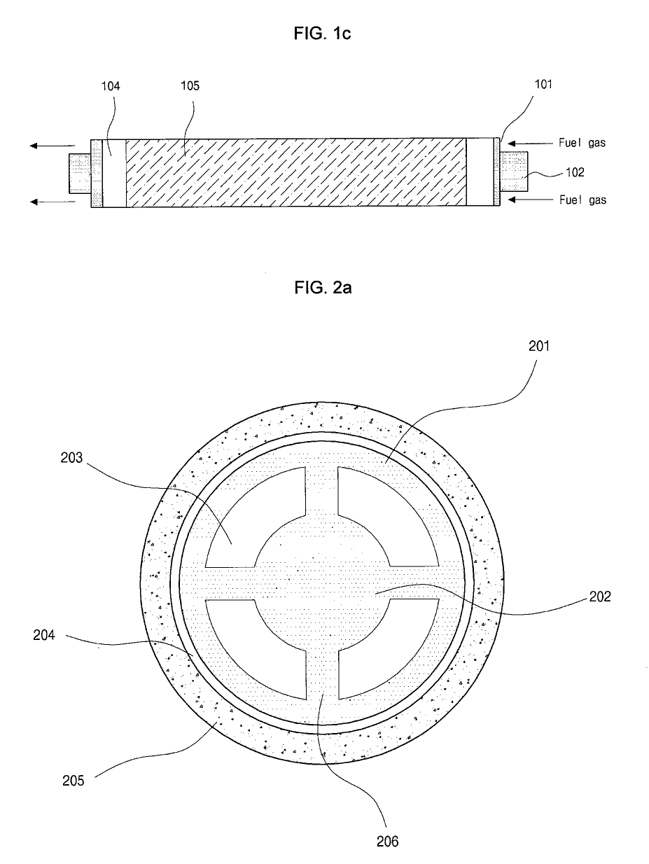

FIG. 1a illustrates a cross-sectional view of an electrode support of a tubular solid oxide fuel cell according to one embodiment of the present invention, FIG. 1b illustrates a cross-sectional view of a solid oxide fuel cell in which an electrolyte layer and an electrode are sequentially coated on the surface of the electrode support illustrated in FIG. 1a, and FIG. 1c illustrates a front view of a cylindrical solid oxide fuel cell constructed such that the core illustrated in FIG. 1b protrudes to facilitate current collection. These figures will be explained together for the purpose of convenience.

As illustrated in FIGS. 1a through 1c, the tubular solid oxide fuel cell comprises: a tubular electrode support including a core 102, an outer wall 101 and a plurality of bridges 106 connecting the core 102 to the outer wall 101; fluid flow channels 103 defined by the bridges 106 between the core 102 and the outer wall 101 of the electrode support; an electrolyte layer 104 coated on the outer surface of the electrode support; and an electrode 105 formed on the outer surface of the electrolyte layer 104.

The core 102, the bridges 106 and the outer wall 101 are made in one piece by molding. There is no restriction on the molding method. For example, the molding may be carried out by slip casting, gel casting, injection molding, extrusion or pressing. Extrusion is the most preferred method.

Although three bridges 106 are illustrated in FIGS. 1a and 1b, their number is not limited. For example, four or more bridges are possible.

The fluid flow channels 103 are defined by the bridges 106 between the core 102 and the outer wall 101. The fluid flow channels 103 are in a circular arc shape and are spaced apart from one another. Fuel gas or air are introduced and discharged through the fluid flow channels (FIG. 1c).

As illustrated in FIGS. 1b and 1c, the electrode support is a constituent of the fuel cell to make the fuel cell mechanically durable and is made of an electrically conductive material, such as ceramic, metal or cermet, so as to function as a fuel electrode or an oxygen electrode. The electrode 105 coated and covered on the outer surface of the electrolyte layer 104 may be an anode or a cathode. The electrode 105 is preferably a cathode. Of course, the electrode 105 may also be a fuel electrode.

The outer surface of the electrode support is covered with the electrolyte layer 104. The electrolyte layer 104 may be formed of a powder of ceramic such as yttria-stabilized zirconia, (La,Sr)(Ga, Mg)O₃, Gd-doped CeO₂, or Ba(Zr,Y)O₃. Typical slurry coating methods, including dip coating and painting, may be used to form the electrolyte layer 104. Other examples of such coating methods include, but are not limited to, vacuum evaporation methods such as chemical vapor deposition and physical vapor deposition.

The core 102 serving as an inner support of the solid oxide fuel cell may protrude so as to be connected to an external manifold or a connection terminal, as illustrated in FIG. 1c.

Since the core 102 is connected to the outer wall 101 by means of the bridges 106 to absorb a mechanical impact applied to the outer wall 101, the outer wall 101 may be designed to have a sufficiently small thickness.

The reduced thickness of the outer wall 101 allows fuel or air to more rapidly reach the electrolyte layer 104. As the thickness of an outer wall of a common cylindrical support electrode decreases, the cross-sectional area of the outer wall through which an electric current passes is decreased, leading to an increase in resistance. In contrast, since the core 102 contributes to an increase in conductivity, the outer wall 101 can be reduced in thickness.

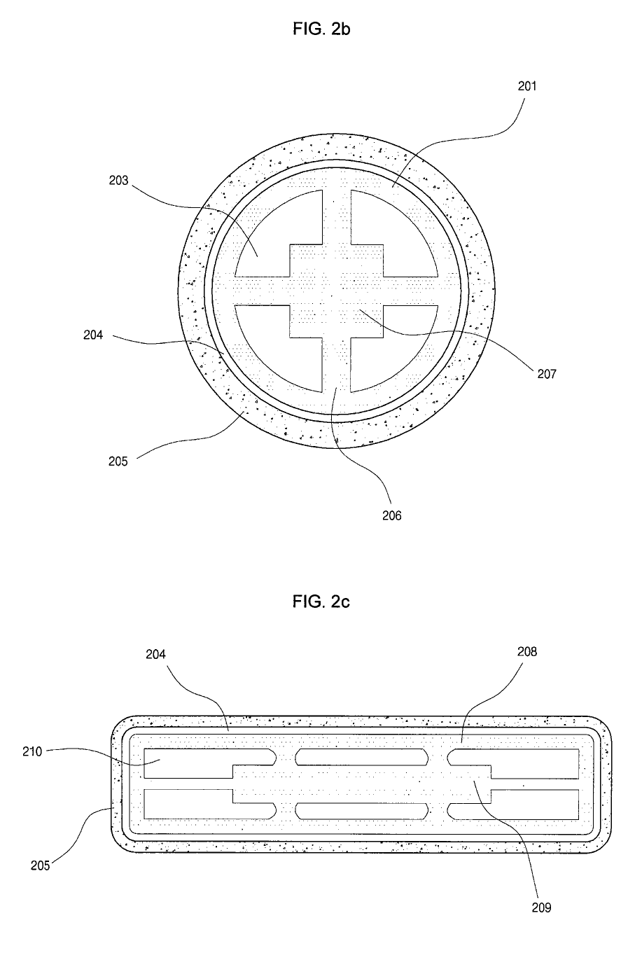

FIGS. 2a through 2c illustrate cross-sectional views of tubular solid oxide fuel cells according to other embodiments of the present invention.

The embodiment of FIG. 2a is substantially the same as that of FIG. 2b. Four bridges 206 are connected to a core 202 and an outer wall 201 in the embodiments of FIGS. 2a and 2b. There is no restriction on the number of the bridges 206. For example, five or more bridges 206 may be formed. An increase in the number of the bridges 206 brings about an improvement in the durability of the fuel cells. However, too many bridges decrease the total cross-sectional area of fluid flow channels 203 through which a fluid (gas or air) flows, thus increasing the risk that the internal pressure of the fluid flow channels 203 may increase.

Unlike the circular core 202 of the embodiment of FIG. 2a, the embodiment of FIG. 2b has a rectangular core 207 defined by the four bridges 206 and the four fluid flow channels 203 in a circular arc shape spaced apart from one another. However, the core 207 may have a polygonal shape in cross section other than circular and tetragonal shapes. The core 207 may have any shape that is suitable for current collection.

Unlike the circular electrode support of the embodiment illustrated in FIGS. 1a through 1c, an electrode support of the embodiment of FIG. 2c has an elongated rectangular shape in cross section adapted to include a rectangular core 209. However, the cross-sectional shape of the electrode support is not limited to circular or tetragonal. For example, the electrode support may have a polygonal (e.g., rhombic) shape in cross section.

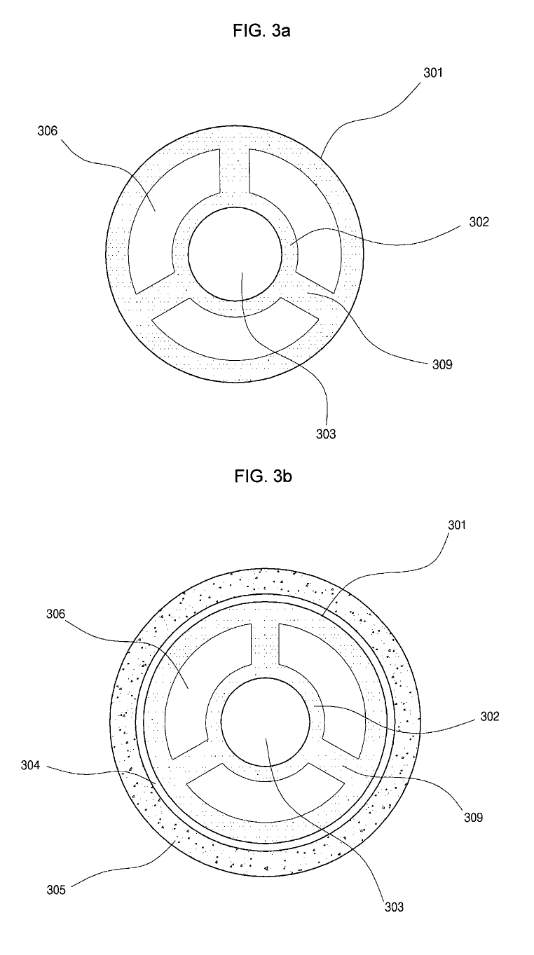

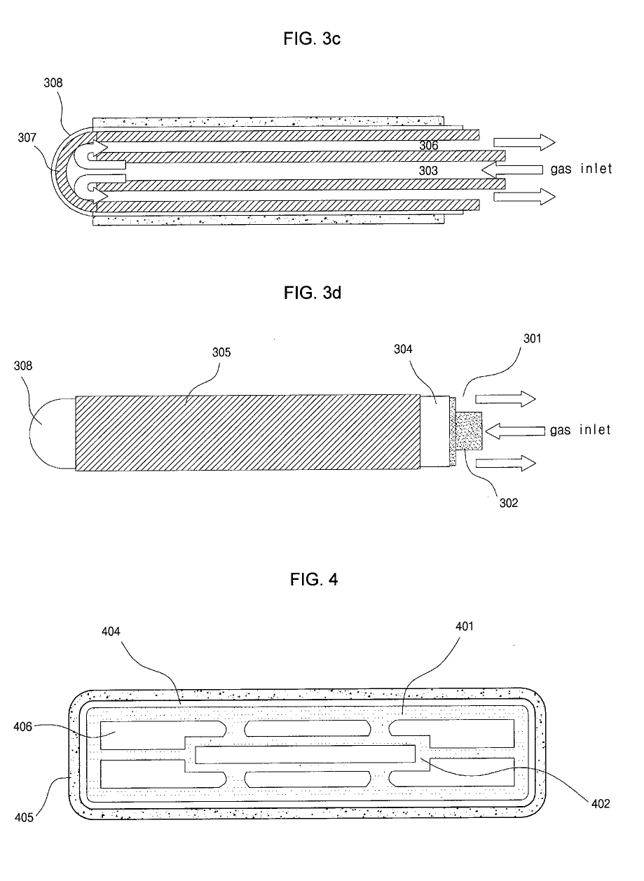

FIG. 3a is a cross-sectional view of an electrode support of a tubular solid oxide fuel cell according to another embodiment of the present invention, FIG. 3b is a cross-sectional view of a solid oxide fuel cell in which an electrolyte and an electrode are sequentially coated on the surface of the electrode support illustrated in FIG. 3a, and FIGS. 3c and 3d are a front view and a cross-sectional view of a cylindrical solid oxide fuel cell constructed such that the core illustrated in FIG. 3b protrudes to facilitate current collection, respectively. These figures will be explained together for the purpose of convenience.

As illustrated in FIGS. 3a through 3d, the tubular solid oxide fuel cell comprises: a tubular electrode support including a core 302, an outer wall 301 and a plurality of bridges 309 connecting the core 302 to the outer wall 301; a fluid supply channel 303 penetrating the central portion of the core 302 of the electrode support; fluid discharge channels 306 defined by the bridges 309 between the core 302 and the outer wall 301 of the electrode support to allow a fluid supplied from the fluid supply channel 303 to be discharged therethrough; an electrolyte layer 304 coated on the outer surface of the electrode support; and an electrode 305 formed on the outer surface of the electrolyte layer 304.

As illustrated in FIG. 3a, the electrode support is constructed such that the core 302 as an inner tube surrounds the fluid supply channel 303 and is connected to the outer wall 301 through the bridges 309. The core 302 supports the outer wall 301 as an outer tube and serves as the fluid supply channel 303 through which a fluid (gas or air) is introduced.

As illustrated in FIG. 3c, the introduced fluid is sufficiently preheated while passing through the fluid supply channel 303 formed inwardly in the lengthwise direction of the electrode support. As illustrated in FIG. 3d, the core 302 as an inner tube of the electrode support protrudes so as to be connected to an external manifold (not shown). With this structure, the core 302 serves as a current collector.

A stopper 307 is formed at one end of the electrode support opposite to an inlet (not denoted by any reference numeral) of the fluid supply channel 303 to close the end of the electrode support. The stopper 307 can induce a fluid supplied through the inlet of the fluid supply channel, which is in flow communication with the fluid discharge channels 306 at the end of the electrode support, to be discharged through the fluid discharge channels 306. The stopper 307 may be formed by molding the same material (e.g., metal, ceramic or cermet) as the tubular electrode support and attaching the molded article to the end of the electrode support using a slurry. The slurry material may be the same as or different from the material for the molded article.

If the stopper 307 is not dense sufficiently to prevent the fluid from leaking out of the electrode support, a cover layer 308 is formed on the outer wall of the stopper 307. The metal-made stopper 307 may be bonded to the electrode support by attaching the stopper 307 to the electrode support using a metal slurry, followed by heating (brazing).

Although three bridges 309 are illustrated in FIGS. 3a and 3b, their number is not limited. For example, four or more bridges are possible. As explained above, a larger number of the bridges 309 make the fuel cell more durable.

The electrode 305 coated and covered on the outer surface of the electrolyte layer 304 may be an anode or a cathode. The electrode 305 is preferably a cathode. Of course, the electrode 305 may also be an anode (a fuel electrode). The electrolyte layer 304 may be formed of a powder of ceramic such as yttria-stabilized zirconia, (La,Sr)(Ga, Mg)O₃, Gd-doped CeO₂, or Ba(Zr,Y)O₃. Typical slurry coating methods, including dip coating and painting, may be used to form the electrolyte layer 304. Other examples of such coating methods include, but are not limited to, vacuum evaporation methods such as chemical vapor deposition and physical vapor deposition.

When it is intended to construct the electrode support as a fuel electrode, a catalyst for fuel processing may be applied to the core 302 as an inner tube to induce catalytic reactions of a hydrocarbon fuel at the fluid supply channel 303 through which the fuel is introduced. As a result of the catalytic reactions, the hydrocarbon fuel is processed into hydrogen and carbon monoxide. A solution or slurry of a metal hydrate or nitride in water is used to apply the catalyst to the core 302. Heat is generated from the core 302 during the fuel processing to increase the temperature of the cell to the reaction temperature.

Of course, the fluid supplied from the fluid supply channel 303 can be discharged through the fluid discharge channels 306 while undergoing electrochemical reactions through the outer wall 301.

The fluid supply channel 303 formed within the electrode support is supported to the outer wall 301 through the bridges 309 to increase an electric current while preheating the fluid introduced thereinto.

FIG. 4 is a cross-sectional view of a tubular solid oxide fuel cell according to another embodiment of the present invention.

The double-walled solid oxide fuel cell of FIG. 4 is substantially the same as the solid oxide fuel cell of FIGS. 3a through 3d in term of its constitution, except that a rectangular inner tube 402 is connected to a rectangular outer wall 401 through bridges (not denoted by any reference numeral) and the overall structure is planar.

The cross-sectional shapes of the inner tube 402 and the outer wall 401 of the planar cell are not limited to rectangular. For example, the inner tube 402 and the outer wall 401 may have any polygonal shape (such as a triangular, trapezoidal or hexagonal shape) in cross section.

As is apparent from the above description, the core of the electrode support is integrally connected to the outer wall of the tubular electrode by the bridges to improve the mechanical durability of the thin outer wall while increasing an electric current through the outer wall, thereby facilitating the fabrication of the tubular solid oxide fuel cell and enhancing the power performance of the cell.

Further, the inner tube of the double-walled electrode support serves as a fluid introduction channel to preheat a fluid without the need for an additional introduction tube. The inner tube contains a catalyst to successively induce processing reactions of a hydrocarbon fuel and electrochemical reactions of the processed fuel, so that the system can be drastically reduced in size while achieving improved efficiency.

The present invention has been described herein with reference to its preferred embodiments. These embodiments are merely illustrative and the present invention is not limited thereto. Those skilled in the art will appreciate that various modifications and variations are possible, without departing from the spirit of the invention as disclosed in the accompanying claims. It is to be understood that such modifications and variations are intended to come within the scope of the invention.

What is claimed is:

1. A tubular solid oxide fuel cell comprising
a tubular electrode support including a core, an outer wall and a plurality of bridges connecting the core to the outer wall,
fluid flow channels defined by the bridges between the core and the outer wall of the electrode support,
an electrolyte layer coated on the outer surface of the electrode support, and
an electrode formed on the outer surface of the electrolyte layer.

2. The fuel cell according to claim 1, wherein the core, the bridges and the outer wall are integrated with each other.

3. The fuel cell according to claim 1, wherein the number of the bridges of the electrode support is at least three.

4. The fuel cell according to claim 1, wherein the electrode support has a circular or polygonal shape in cross section.

5. The fuel cell according to any one of claims 1 to 4, wherein the electrode is a fuel electrode or an oxygen electrode.

6. The fuel cell according to any one of claims 1 to 4, wherein the electrolyte layer is formed by dip coating or painting a powder of a ceramic material selected from yttria-stabilized zirconia, (La,Sr)(Ga, Mg)O₃, Gd-doped CeO₂ and Ba(Zr,Y)O₃ on the electrode support.

7. A tubular solid oxide fuel cell comprising
a tubular electrode support including a core, an outer wall and a plurality of bridges connecting the core to the outer wall,
a fluid supply channel penetrating the central portion of the core of the electrode support,
fluid discharge channels defined by the bridges between the core and the outer wall of the electrode support to allow a fluid supplied from the fluid supply channel to be discharged therethrough,
an electrolyte layer coated on the outer surface of the electrode support, and
an electrode formed on the outer surface of the electrolyte layer.

8. The fuel cell according to claim 7, further comprising a stopper formed at one end of the electrode support opposite to an inlet of the fluid supply channel to close the end of the electrode support and to allow a fluid supplied through the inlet of the fluid supply channel, which is in flow communication with the fluid discharge channels at the end of the electrode support, to be discharged through the fluid discharge channels.

9. The fuel cell according to claim 7, wherein the fluid is either fuel gas or air.

10. The fuel cell according to claim 7, wherein the core, the bridges and the outer wall are integrated with each other.

11. The fuel cell according to claim 7, wherein the number of the bridges of the electrode support is at least three.

12. The fuel cell according to claim 7, wherein the electrode is a cathode or an oxygen electrode.

13. The fuel cell according to claim 7, wherein the electrolyte layer is formed by dip coating or painting a yttria ceramic powder on the electrode support.

14. The fuel cell according to claim 7, wherein the fluid supplied from the fluid supply channel is discharged through the fluid discharge channels while undergoing electrochemical reactions through the outer wall.

15. The fuel cell according to claim 7, wherein the fluid supply channel formed within the electrode support is supported to the outer wall through the bridges to increase an electric current while preheating the fluid introduced thereinto.

16. The fuel cell according to claim 7, wherein the fluid supply channel formed within the electrode support contains or is coated with a catalytic material for inducing processing reactions of the fluid and successive electrochemical reactions to generate an electric current.

17. The fuel cell according to claim 16, wherein the catalytic material contained in or coated on the fluid supply channel induces catalytic combustion of the fuel to increase the overall temperature of the cell.

18. The fuel cell according to claim 7, wherein the electrode support has a circular or polygonal shape in cross section.

19. The fuel cell according to claim 8, wherein the stopper is formed with a cover layer on the outer wall thereof to prevent the fluid from leaking out of the electrode support.
